(19) United States
(12) Patent Application Publication
(10) Pub. No.: US 2023/0059934 A1
(43) Pub. Date: Feb. 23, 2023

(54) SYSTEM AND METHOD FOR COMPLETION OF AN AUTOMATED TASK SEQUENCE

(71) Applicant: The Toronto-Dominion Bank, Toronto (CA)

(72) Inventors: Yanqing ZHOU, Vaughan (CA); Pia SCHMIDT-HANSEN, Toronto (CA); Mary Ann Olmos RODIL, Markham (CA); Sasha Bernadette PEREIRA, Mississauga (CA); Sanaa Ishak MOHEDDIN, Toronto (CA)

(73) Assignee: The Toronto-Dominion Bank, Toronto (CA)

(21) Appl. No.: 17/406,200

(22) Filed: Aug. 19, 2021

(51) Int. Cl. G06Q 10/06

(52) U.S. Cl. CPC G06Q 10/06316; G06Q 10/0633; G06Q 10/063112

(57) ABSTRACT

A server computer system, comprises a processor; a communications module coupled to the processor; and a memory coupled to the processor, the memory storing instructions that, when executed, configure the processor to receive a claim for processing, the claim including claim data identifying a claim type and an account associated with the claim; route the claim, based on the claim data, to an automated task sequence for processing the claim; determine that a particular task cannot be completed within the automated task sequence; responsive to determining that the particular task cannot be completed within the automated task sequence, route the claim to a manual task completion module and update the claim data to indicate that the particular task cannot be completed within the automated task sequence; receive the claim from the manual task completion module; analyze the claim data to identify a code, the code identifying a task within the automated task sequence that is next to be completed for the claim; and route the claim to the identified task within the automated task sequence that is next to be completed for the claim.

### TECHNICAL FIELD

The present disclosure relates to systems and methods for completion of an automated task sequence.

### BACKGROUND

Robotic process automation may utilize artificial intelligence to complete the processing of a claim. If an error occurs, human intervention is required to complete the processing of the claim.

### BRIEF DESCRIPTION OF THE DRAWINGS

Reference will now be made, by way of example, to the accompanying drawings which show example embodiments of the present application and in which:

FIG. 1 is a schematic diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 shows an example automated task sequence;

FIG. 4 shows another example automated task sequence; and

FIG. 5 shows, in flowchart form, an example method for completion of an automated task sequence.

Like reference numerals are used in the drawings to denote like elements and features.

### DETAILED DESCRIPTION OF EXAMPLE EMBODIMENTS

In an aspect there is provided a server computer system, comprising a processor; a communications module coupled to the processor; and a memory coupled to the processor, the memory storing instructions that, when executed, configure the processor to receive a claim for processing, the claim including claim data identifying a claim type and an account associated with the claim; route the claim, based on the claim data, to an automated task sequence for processing the claim; determine that a particular task cannot be completed within the automated task sequence; responsive to determining that the particular task cannot be completed within the automated task sequence, route the claim to a manual task completion module and update the claim data to indicate that the particular task cannot be completed within the automated task sequence; receive the claim from the manual task completion module; analyze the claim data to identify a code, the code identifying a task within the automated task sequence that is next to be completed for the claim; and route the claim to the identified task within the automated task sequence that is next to be completed for the claim.

In one or more embodiments, the identified task within the automated task sequence is a different task than the particular task that cannot be completed.

In one or more embodiments, the automated task sequence includes a plurality of hand-in points and the identified task within the automated task sequence is associated with one of the hand-in points.

In one or more embodiments, determining that the particular task cannot be completed within the automated task sequence includes determining that a second claim has been received for the account associated with the claim.

In one or more embodiments, the claim data includes data identifying one or more transactions flagged as being potentially fraudulent.

In one or more embodiments, determining that the particular task cannot be completed within the automated task sequence includes determining that a transaction has been previously completed at a merchant that is a same merchant who completed the one or more transactions flagged as being potentially fraudulent.

In one or more embodiments, determining that the particular task cannot be completed within the automated task sequence includes determining that one or more data points are missing.

In one or more embodiments, the claim type includes a claim for one or more fraudulent transactions.

In one or more embodiments, the instructions, when executed, further configure the processor to, responsive to routing the claim to the identified task within the automated task sequence that is next to be completed for the claim, perform subsequent tasks to complete the automated task sequence.

In one or more embodiments, the claim data is in a machine-readable format and the code identifying the task within the automated task sequence is included as metadata of the claim data.

According to another aspect there is provided a method comprising receiving a claim for processing, the claim including claim data identifying a claim type and an account associated with the claim; routing the claim, based on the claim data, to an automated task sequence for processing the claim; determining that a particular task cannot be completed within the automated task sequence; responsive to determining that the particular task cannot be completed within the automated task sequence, routing the claim to a manual task completion module and updating the claim data to indicate that the particular task cannot be completed within the automated task sequence; receiving the claim from the manual task completion module; analyzing the claim data to identify a code, the code identifying a task within the automated task sequence that is next to be completed for the claim; and routing the claim to the identified task within the automated task sequence that is next to be completed for the claim.

In one or more embodiments, the identified task within the automated task sequence is a different task than the particular task that cannot be completed.

In one or more embodiments, the automated task sequence includes a plurality of hand-in points and the identified task within the automated task sequence is associated with one of the hand-in points.

In one or more embodiments, determining that the particular task cannot be completed within the automated task sequence includes determining that a second claim has been received for the account associated with the claim.

In one or more embodiments, the claim data includes data identifying one or more transactions flagged as being potentially fraudulent.

In one or more embodiments, determining that the particular task cannot be completed within the automated task sequence includes determining that a transaction has been previously completed at a merchant that is a same merchant who completed the one or more transactions flagged as being potentially fraudulent.

In one or more embodiments, determining that the particular task cannot be completed within the automated task sequence includes determining that one or more data points are missing.

In one or more embodiments, the claim type includes a claim for one or more fraudulent transactions.

In one or more embodiments, the method further comprises responsive to routing the claim to the identified task within the automated task sequence that is next to be completed for the claim, performing subsequent tasks to complete the automated task sequence.

According to another aspect there is provided a non-transitory computer readable storage medium comprising processor-executable instructions which, when executed, configure a processor to receive a claim for processing, the claim including claim data identifying a claim type and an account associated with the claim; route the claim, based on the claim data, to an automated task sequence for processing the claim; determine that a particular task cannot be completed within the automated task sequence; responsive to determining that the particular task cannot be completed within the automated task sequence, route the claim to a manual task completion module and update the claim data to indicate that the particular task cannot be completed within the automated task sequence; receive the claim from the manual task completion module; analyze the claim data to identify a code, the code identifying a task within the automated task sequence that is next to be completed for the claim; and route the claim to the identified task within the automated task sequence that is next to be completed for the claim.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of ... or...” is intended to cover any one or more of the listed elements, including any one of the listed elements alone, any sub-combination, or all of the elements, without necessarily excluding any additional elements, and without necessarily requiring all of the elements.

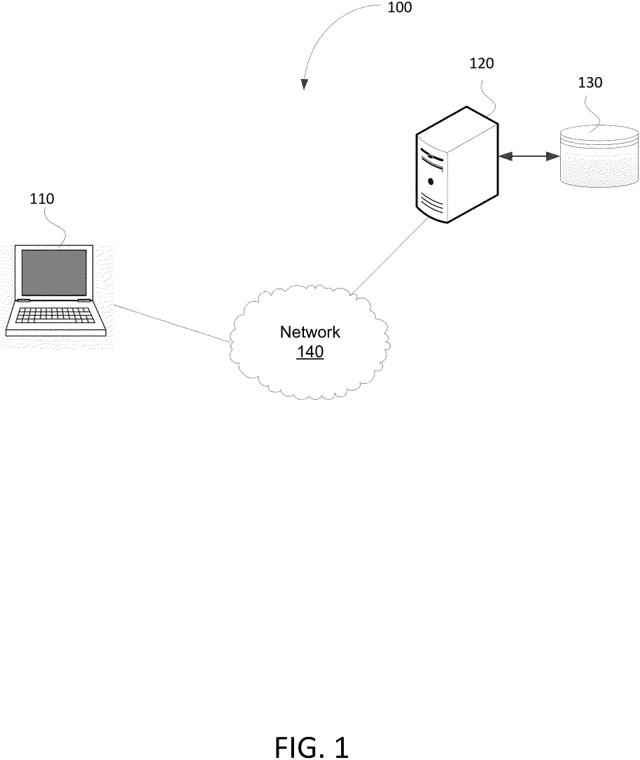

FIG. 1 illustrates an exemplary system 100 consistent with certain disclosed embodiments. As shown in FIG. 1, the system 100 may include a computing device 110, a server computer system 120, a database 130 associated with the server computer system 120 and a network 140 connecting one or more of the components of the system 100.

The computing device 110 may be a laptop computer as shown in FIG. 1. However, the computing device 110 may be a computing device of another type such as for example a personal computer, a tablet computer, a notebook computer, a hand-held computer, a personal digital assistant, a portable navigation device, a mobile phone, a wearable computing device (e.g., a smartwatch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. The computing device 110 may store software instructions that cause the computing device 110 to establish communications with the server computer system 120.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The server computer system 120 may be a financial institution server and may maintain a database 130 that includes various data records. At least some of the data records may be associated with customer bank accounts and/or customer credit card accounts. For example, a data record may reflect an amount of value stored in a customer bank account. As another example, a data record may store transaction data associated with one or more transactions made on a credit card. The transaction data may include information related to the one or more transactions such as for example a transaction location (e.g. the name of a merchant who completed the transaction), a transaction date, a transaction amount, etc.

The server computer system 120 may include a robotic process automation module that is used to complete automatic processing of a claim. For example, the robotic automation module may utilize artificial intelligence and/or machine learning techniques to automate the processing of a claim. The robotic process automation module may include a plurality of automated task sequences to process a claim. Each automated task sequence may include a plurality of tasks that are to be automatically completed to process a claim. Each automated task sequence may be associated with a particular claim type.

The server computer system 120 may include a manual task completion module that may be used to complete one or more tasks. The manual task completion module may communicate with the computing device 110 to complete one or more tasks. The one or more tasks may be completed by a human operator operating the computing device 110.

The computing device 110 and the server computer system 120 may be in geographically disparate locations. Put differently, the computing device 110 may be remote from the server computer system 120.

The network 140 is a computer network. In some embodiments, the network 140 may be an internetwork such as may be formed of one or more interconnected computer networks. For example, the network 140 may be or may include an Ethernet network, an asynchronous transfer mode (ATM) network, a wireless network, or the like.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components. For example, the system 100 may include multiple server computer systems.

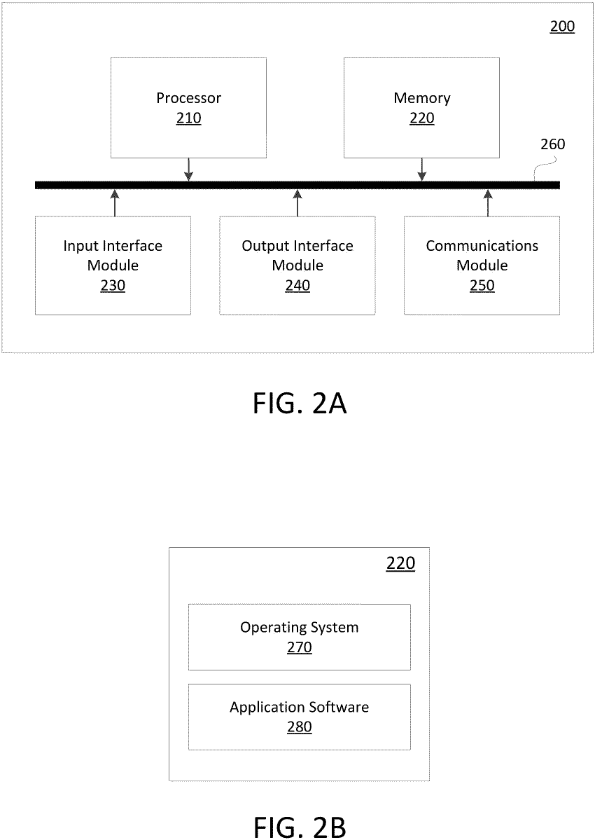

FIG. 2A is a high-level operation diagram of an example computer device 200. In some embodiments, the example computer device 200 may be exemplary of one or more of the computing device 110 and the server computer system 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi (TM), using Bluetooth (TM) or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and application software 280.

The operating system 270 is software. The operating system 270 allows the application software 280 to access the processor 210, the memory 220, the input interface module 230, the output interface module 240 and the communications module 250. The operating system 270 may be, for example, Apple iOS™, Google Android™, Linux™, Microsoft Windows™, or the like.

The application software 280 adapts the example computer device 200, in combination with the operating system 270, to operate as a device performing particular functions. In some embodiments, the application software 280 may include a claim processing application. The claim processing application may engage the robotic process automation module and/or the manual task completion module to process one or more claims.

As mentioned, the robotic process automation module is used to complete automatic processing of a claim. The robotic process automation module may include a plurality of automated task sequences to process a claim. Each automated task sequence may be associated with a particular claim type and may include a plurality of tasks that are to be automatically completed to process a claim of the particular claim type.

The tasks include server or computer operations that must be completed to process the claim. For example, the one or more tasks may be performed by one or more specially programmed computer systems which may be referred to as “bots”. The bots may utilize artificial intelligence, natural language processing (NLP), fuzzy logic and/or machine learning to complete the one or more tasks. The bots may engage one or more application programming interfaces (APIs) to obtain data related to the completion of one or more tasks.

The automated task sequences include a plurality of tasks that are to be performed to process a claim without human intervention. The tasks include server or computer operations that must be completed to process the claim. The tasks within an automated task sequence are performed in manners that are different than if the tasks were to be performed manually. Put another way, the tasks that are to be performed within an automated task sequence to process a claim of a particular claim type may be different from tasks that would be required to be performed to process the claim manually for the particular claim type.

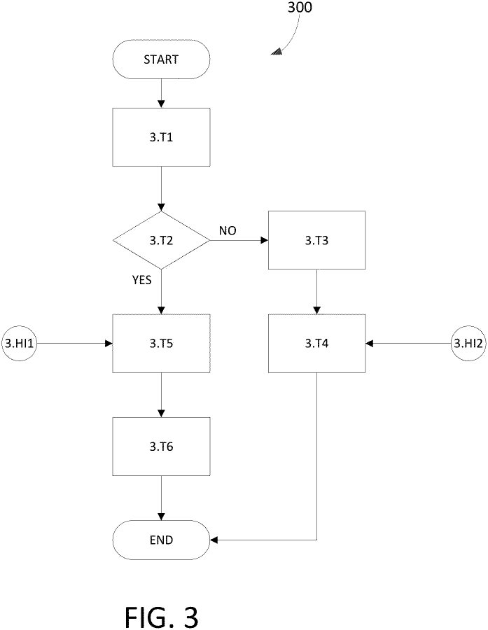

An example automated task sequence 300 is shown in FIG. 3. The automated task sequence 300 may be associated with a first claim type. The automated task sequence 300 includes a plurality of tasks that are to be completed to process a claim that is of the first claim type. At least some of the tasks are to be completed in series.

The automated task sequence 300 includes a task 3.T1. Upon completion of the task 3.T1, the automated task sequence 300 includes a task 3.T2. The task 3.T2 requires a determination step. Responsive to determining “NO”, the automated task sequence 300 includes a task 3.T3. Upon completion of the task 3.T3, the automated task sequence 300 includes task 3.T4. Upon completion of the task 3.T4, the automated task sequence 300 is completed.

During the task 3.T2, responsive to determining “YES”, the automated task sequence 300 includes a task 3.T5. Upon completion of the task 3.T5, the automated task sequence 300 includes task 3.T6. Upon completion of the task 3.T6, the automated task sequence 300 is completed.

The automated task sequence 300 includes a first hand-in point 3.HI1 and a second hand-in point 3.HI2. The first hand-in point 3.HI1 is connected to the task 3.T5 and the second hand-in point 3.HI2 is connected to the task 3.T4. Put another way, the task 3.T5 is associated with the first hand-in point 3.HI1 and the task 3.T4 is associated with the second hand-in point 3.HI2. As will be described in more detail, in the event that a particular task within the automated task sequence 300 cannot be completed by the robotic process automation module, the server computer system 120 may engage the manual task completion module. The robotic process automation module may receive, from the manual task completion module, claim data that includes a code identifying the first hand-in point 3.HI1 or the second hand-in point 3.HI2.

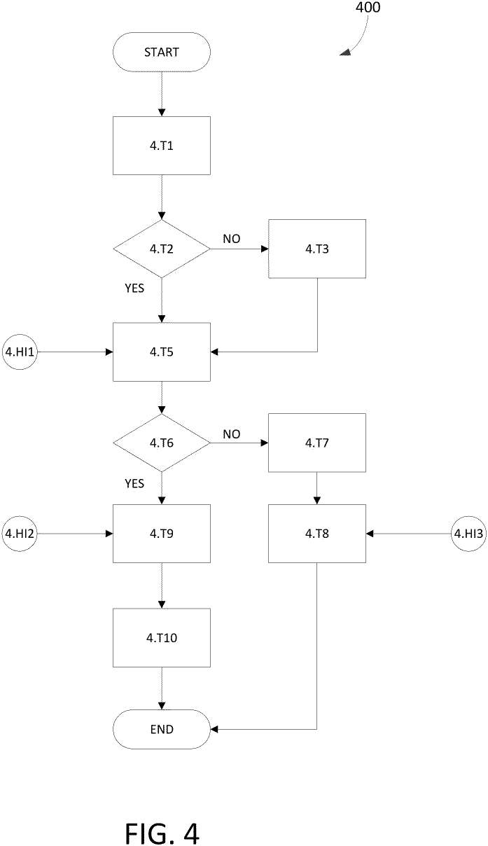

Another example automated task sequence 400 is shown in FIG. 4. The automated task sequence 400 may be associated with a second claim type. The automated task sequence 400 includes a plurality of tasks that are to be completed to process a claim that is of the second claim type.

The automated task sequence 400 includes a task 4.T1. Upon completion of the first task 4.T1, the automated task sequence 400 includes a task 4.T2. The task 4.T2 requires a determination step. Responsive to determining “NO”, the automated task sequence 400 includes a task 4.T3. Upon completion of the task 4.T3, the automated task sequence 300 proceeds to a task 4.T5.

During the task 4.T2, responsive to determining “YES”, the automated task sequence 300 includes the task 4.T5. Upon completion of the task 4.T5, the automated task sequence 400 includes a task 4.T6. The task 4.T6 requires a determination step. Responsive to determining “NO”, the automated task sequence 400 includes a task 4.T7. Upon completion of the task 4.T7, the automated task sequence 400 includes task 4.T8. Upon completion of the task 4.T8, the automated task sequence 400 is completed.

During the task 4.T6, responsive to determining “YES”, the automated task sequence 300 includes a task 4.T9. Upon completion of the task 4.T9, the automated task sequence 400 includes task 4.T10. Upon completion of the task 4.T10, the automated task sequence 400 is completed.

The automated task sequence 400 includes a first hand-in point 4.HI1, a second hand-in point 4.HI2 and a third hand-in point 4.HI3. The first hand-in point 4.HI1 is connected to the task 4.T5, the second hand-in point 4.HI2 is connected to the task 4.T9 and the third hand-in point 4.HI3 is connected to the task 4.T8. Put another way, the task 4.T5 is associated with the first hand-in point 4.HI1, the task 4.T9 is associated with the second hand-in point 4.HI2 and the task 4.T8 is associated with the third hand-in point 4.HI3. As will be described in more detail, in the event that a particular task within the automated task sequence 400 cannot be completed by the robotic process automation module, the server computer system 120 may engage the manual task completion module. The robotic process automation module may receive, from the manual task completion module, claim data that includes a code identifying the first hand-in point 4.HI1, the second hand-in point 4.HI2 or the third hand-in point 4.HI3.

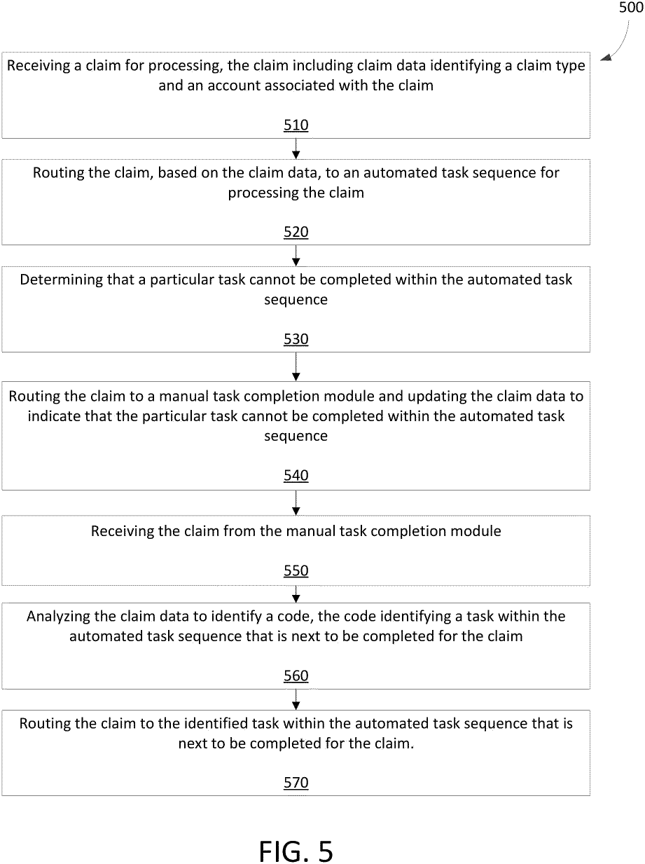

Reference is made to FIG. 5, which illustrates, in flowchart form, a method 500 for completion of an automated task sequence. The method 500 may be implemented by a computing device having suitable processor-executable instructions for causing the computing device to carry out the described operations. The method 500 may be implemented, in whole or in part, by the server computer system 120. The server computer system 120 may off-load some operations of the method 500 to the computing device 110 (FIG. 1).

The method 500 includes receiving a claim for processing, the claim including claim data identifying a claim type and an account associated with the claim (step 510).

The claim may be received by the server computer system 120 in a number of ways. In at least some embodiments, a claim may be generated in response to receiving an indication from a customer that one or more transactions made on their credit card is fraudulent. For example, using a computing device, a customer may log into a mobile banking application. Within the mobile banking application, the customer may review transactions made on their credit card. The customer may determine that one or more of the transactions are fraudulent and in response, the customer may select a selectable option to flag the one or more transactions as being fraudulent. Responsive to the customer selecting the selectable option to flag the one or more transactions as being fraudulent, the server computer system 120 may perform operations to initiate or generate a claim.

As another example, a customer may visit a physical branch of a financial institution to dispute or flag one or more transactions as being fraudulent. In this example, a computing device located at the physical branch may be used to send data to the server computer system 120 and the server may perform operations to initiate or generate a claim.

As yet another example, the customer may engage in a live-chat with a bot specially programmed to utilize NLP to send and receive messages. In this example, the customer may enter the live-chat within a mobile banking application and may exchange messages with the bot. The bot may prompt the customer to provide information related to the claim and in this manner the server computer system 120 may perform operations to initiate or generate a claim using the provided information.

Generating the claim may include generating claim data and storing the claim data in memory. The claim may be generated such that the claim data is in machine-readable format that can be processed by a computer without human intervention. The claim data identifies the claim type and the account associated with the claim. For example, the claim may be based on a customer selecting one or more transactions made on a credit card as being fraudulent and as such the claim data may identify the claim type as “fraudulent charges” and may identify the account as being the credit card account of the customer.

The method 500 includes routing the claim, based on the claim data, to an automated task sequence for processing the claim (step 520).

The server computer system 120 may analyze the claim data to determine a particular automated task sequence for processing the claim. For example, the server computer system 120 may analyze the claim data to determine the claim type and may determine the particular automated task sequence for processing the claim based on the claim type. In the example where the claim type is “fraudulent charges” the claim may be routed to an automated task sequence for processing “fraudulent charges” claims.

In one or more embodiments, the server computer system 120 may engage a machine-learning module to classify a claim based on claim data. For example, the machine-learning module may include one or more classifiers trained to analyze claim data to predict a probability that the claim belongs to one or more claim categories. Each classifier may be a binary classifier or a multiclass classifier. The one or more classifiers may be trained using training data. The training data may include a large number of example cases which map inputs to expected outputs. Machine-learning algorithms such as for example convolutional neural networks (CNNs), support-vector machine (SVM) and/or Adaboost may be used. During classification, when it is determined that the claim is likely to belong to a particular claim type, it may be determined that the claim is of the particular claim type and the claim may be routed to an automated task sequence for processing claims of the particular claim type.

To route the claim to the automated task sequence, the server computer system 120 may engage the robotic process automation module and the robotic process automation module may begin to process the claim. As mentioned, the automated task sequence includes a plurality of tasks that are to be completed to process the claim and as such the robotic process automation module performs operations or engages one or more bots to complete the tasks in the automated task sequence.

The method 500 includes determining that a particular task cannot be completed within the automated task sequence (step 530).

Determining that a particular task cannot be completed within the automated task sequence may include determining that one or more data points are missing. For example, one of the tasks in the automated task sequence may require data indicating why the transaction has been flagged as being potentially fraudulent. When performing the task, the robotic process automation module may determine that the data indicating why the transaction has been flagged as being potentially fraudulent is missing and as such the task cannot be completed.

Determining that a particular task cannot be completed within the automated task sequence may include determining that a second claim has been received for the account associated with the claim. The second claim may include one or more transactions that are also included in the claim received during step 510 or may include different transactions. In this example, the automated task sequence may include a task for determining if a second claim has been received for the account associated with the claim. Responsive to determining that the second claim has been received for the account associated with the claim, it may be determined that a particular task cannot be completed within the automated task sequence.

Determining that a particular task cannot be completed within the automated task sequence may include determining that a transaction has been previously completed at a merchant that is a same merchant who completed the one or more transactions flagged as being potentially fraudulent. For example, the automated task sequence may include a task for analyzing transactions made by the customer within the past six (6) months to determine if the customer has previously made any purchases at the same merchant where the potentially fraudulent transaction was completed. Responsive to determining that a transaction has been previously completed at the merchant that is the same merchant who completed the one or more transactions flagged as being potentially fraudulent, it may be determined that a particular task cannot be completed within the automated task sequence.

Responsive to determining that the particular task cannot be completed within the automated task sequence, the method includes routing the claim to a manual task completion module and updating the claim data to indicate that the particular task cannot be completed within the automated task sequence (step 540).

When it is determined that the particular task cannot be completed within the automated task sequence, the claim is routed to the manual task completion module. In this embodiment, the manual task completion module may send a signal to the computing device 110 and the computing device 110 may display, on a display screen associated therewith, a request for the human operator to perform one or more manual tasks. The request for the human operator to perform one or more manual tasks may be generated based on the claim data indicating that the particular task cannot be completed within the automated task sequence. The human operator may be an agent of the financial institution.

The claim data is updated automatically by the robotic process automation module to indicate that the particular task cannot be completed within the automated task sequence. For example, responsive to determining that one or more data points are missing, the claim data may be updated to indicate the missing data points. The request to perform one or more manual tasks may include obtaining the missing data points. Put another way, in this example, the manual task completion module may be engaged and the human operator may perform one or more manual tasks to obtain the missing data points.

As another example, responsive to determining that the second claim has been received for the account associated with the claim, the claim data may be updated to indicate that a second claim has been received for the account associated with the claim. The request to perform one or more manual tasks may include analyzing the claim and the second claim to determine if the two claims can be merged. Put another way, in this example, the manual task completion module may be engaged and the human operator may perform one or more manual tasks to merge the claim and the second claim when it is determined that the two claims are to be merged.

As another example, responsive to determining that a transaction has been previously completed at the merchant that is the same merchant who completed the one or more transactions flagged as being potentially fraudulent, the claim data may be updated to indicate that a transaction has been previously completed at the merchant that is the same merchant who completed the one or more transactions flagged as being potentially fraudulent. The request to perform one or more manual tasks may include conducting a review of the transactions and/or contacting the customer to discuss. Put another way, in this example, the manual task completion module may be engaged and the human operator may perform one or more manual tasks to conduct a manual review and/or to contact the customer to discuss.

Upon completion of the one or more manual tasks, the claim data is updated by the human operator to include a code. The claim data may be updated by the human operator using an input device such as a keyboard associated with the computing device 110. In one example, upon completion of the one or more manual tasks, the computing device 110 may cause the display of a message to the human operator requesting the human operator to input the code. As another example, upon completion of the one or more manual tasks, a selectable option displayed on a display screen of the computing device 110 may be selected by the human operator and in response, the computing device may cause the display of a window requesting the human operator to input the code. Once the code has been input by the human operator, the code may be included with the claim data or may be included as metadata of the claim data.

The code identifies a task within the automated task sequence that is next to be completed for the claim. The identified task within the automated task sequence may be a different task than the particular task that cannot be completed. For example, the task that is next to be completed for the claim may not be the next task in the automated task sequence, rather it may be a different task. For example, with reference to the automated task sequence 300, it may be determined that the task 3.T1 cannot be completed. Responsive to determining that the task 3.T1 cannot be completed, the manual task completion module may be engaged. Upon completion of the one or more manual tasks, the claim data may be updated to include a code that, when analyzed, identifies the hand-in point 3.HI1 which is associated with the task 3.T5. As another example, responsive to determining that the task 3.T1 cannot be completed, the manual task module may be engaged and upon completion of the one or more manual tasks, the claim data may be updated to include a code that, when analyzed, identifies the task 3.T6 as the next task to be completed for the claim.

The code may be a code that is unique to a particular task within the automated task sequence. The code may be a secret code that is only known to the human operator and may include a plurality of alphanumeric characters and/or may include one or more keywords. The code may additionally identify the claim and/or the account associated with the claim. For example, the claim may be assigned a claim number and the code may include the claim number and alphanumeric characters that identify the particular task within the automated task sequence. The code may be encrypted. For example, an encryption key pair may be used and the computing device 110 may encrypt the claim data prior to sending the claim data to the server computer system 120. The code may be included in metadata of the claim data.

The method 500 includes receiving the claim from the manual task completion module (step 550).

Once the human operator has completed the one or more manual tasks and updated the claim data to include the code, the claim is sent back to the robotic process automation module.

The method 500 includes analyzing the claim data to identify a code, the code identifying a task within the automated task sequence that is next to be completed for the claim (step 560).

The claim data is analyzed by the robotic process automation module to identify the code. As mentioned, the claim data may be encrypted and as such an encryption key may be used by the server computer system 120 to decrypt the claim data. Using the code, the server computer system 120 identifies the task within the automated task sequence that is next to be completed for the claim. For example, the server computer system 120 may use a look-up table to identify the task within the automated task sequence that is next to be completed for the claim. In another example, the code itself may identify the task within the automated task sequence that is next to be completed for the claim.

The identified task within the automated task sequence may be a different task than the particular task that cannot be completed. For example, the task that is next to be completed for the claim may not be the next task in the automated task sequence, rather it may be a different task.

The method 500 includes routing the claim to the identified task within the automated task sequence that is next to be completed for the claim (step 570).

The claim is routed to the identified task within the automated task sequence. Subsequent tasks are performed to complete the automated task sequence to process the claim. It will be appreciated that the method 500 may be performed for the subsequent tasks and the manual task completion module may be completed should it be determined that one or more of the subsequent tasks cannot be completed. In embodiments where the claim type is “fraudulent charges” the subsequent tasks may include claim adjudication, reimbursement and fraud reporting.

In manners described herein, the manual estimation module is only engaged when it is determined that a particular task cannot be completed within an automated task sequence. By analyzing claim data to identify a code that identifies a task within the automated task sequence that is next to be completed for the claim, the automated task sequence may complete the processing of the claim without performing any unnecessary or redundant steps. Further, the manual estimation module is not relied upon to complete the processing of the claim, but rather only to complete one or more manual tasks and to insert the claim into an appropriate task within the automated task sequence. As such, manual handle time for claim processing is reduced.

It will be appreciated that in embodiments described herein the manual estimation module is engaged to perform one or more manual tasks and these manual tasks are different from the tasks in the automated task sequence. Put another way, the manual estimation module is not engaged to simply perform one or more of the tasks that are included in the automated task sequence. Rather, the manual estimation module is engaged to correct faults and/or obtain additional data such that the automated task sequence may be completed without human intervention. The corrected faults and/or additional data may result in one or more of the tasks in the automated task sequence being redundant and/or unnecessary and as such the code may be used to ensure that the claim is processed using the automated task sequence in an efficient manner.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. A server computer system, comprising:
a processor;
a communications module coupled to the processor; and
a memory coupled to the processor, the memory storing instructions that, when executed, configure the processor to:
receive a claim for processing, the claim including claim data identifying a claim type and an account associated with the claim;
route the claim, based on the claim data, to an automated task sequence for processing the claim;
determine that a particular task cannot be completed within the automated task sequence;
responsive to determining that the particular task cannot be completed within the automated task sequence, route the claim to a manual task completion module and update the claim data to indicate that the particular task cannot be completed within the automated task sequence;
receive the claim from the manual task completion module;
analyze the claim data to identify a code, the code identifying a task within the automated task sequence that is next to be completed for the claim; and
route the claim to the identified task within the automated task sequence that is next to be completed for the claim.

2. The server computer system of claim 1, wherein the identified task within the automated task sequence is a different task than the particular task that cannot be completed.

3. The server computer system of claim 1, wherein the automated task sequence includes a plurality of hand-in points and the identified task within the automated task sequence is associated with one of the hand-in points.

4. The server computer system of claim 1, wherein determining that the particular task cannot be completed within the automated task sequence includes determining that a second claim has been received for the account associated with the claim.

5. The server computer system of claim 1, wherein the claim data includes data identifying one or more transactions flagged as being potentially fraudulent.

6. The server computer system of claim 5, wherein determining that the particular task cannot be completed within the automated task sequence includes determining that a transaction has been previously completed at a merchant that is a same merchant who completed the one or more transactions flagged as being potentially fraudulent.

7. The server computer system of claim 1, wherein determining that the particular task cannot be completed within the automated task sequence includes determining that one or more data points are missing.

8. The server computer system of claim 1, wherein the claim type includes a claim for one or more fraudulent transactions.

9. The server computer system of claim 1, wherein the instructions, when executed, further configure the processor to:
responsive to routing the claim to the identified task within the automated task sequence that is next to be completed for the claim, perform subsequent tasks to complete the automated task sequence.

10. The server computer system of claim 1, the claim data is in a machine-readable format and the code identifying the task within the automated task sequence is included as metadata of the claim data.

11. A method comprising:
receiving a claim for processing, the claim including claim data identifying a claim type and an account associated with the claim;
routing the claim, based on the claim data, to an automated task sequence for processing the claim;
determining that a particular task cannot be completed within the automated task sequence;
responsive to determining that the particular task cannot be completed within the automated task sequence, routing the claim to a manual task completion module and updating the claim data to indicate that the particular task cannot be completed within the automated task sequence;
receiving the claim from the manual task completion module;
analyzing the claim data to identify a code, the code identifying a task within the automated task sequence that is next to be completed for the claim; and
routing the claim to the identified task within the automated task sequence that is next to be completed for the claim.

12. The method of claim 11, wherein the identified task within the automated task sequence is a different task than the particular task that cannot be completed.

13. The method of claim 11, wherein the automated task sequence includes a plurality of hand-in points and the identified task within the automated task sequence is associated with one of the hand-in points.

14. The method of claim 11, wherein determining that the particular task cannot be completed within the automated task sequence includes determining that a second claim has been received for the account associated with the claim.

15. The method of claim 11, wherein the claim data includes data identifying one or more transactions flagged as being potentially fraudulent.

16. The method of claim 15, wherein determining that the particular task cannot be completed within the automated task sequence includes determining that a transaction has been previously completed at a merchant that is a same merchant who completed the one or more transactions flagged as being potentially fraudulent.

17. The method of claim 11, wherein determining that the particular task cannot be completed within the automated task sequence includes determining that one or more data points are missing.

18. The method of claim 11, wherein the claim type includes a claim for one or more fraudulent transactions.

19. The method of claim 11, further comprising:
responsive to routing the claim to the identified task within the automated task sequence that is next to be completed for the claim, performing subsequent tasks to complete the automated task sequence.

20. A non-transitory computer readable storage medium comprising processor-executable instructions which, when executed, configure a processor to:
receive a claim for processing, the claim including claim data identifying a claim type and an account associated with the claim;
route the claim, based on the claim data, to an automated task sequence for processing the claim;
determine that a particular task cannot be completed within the automated task sequence;
responsive to determining that the particular task cannot be completed within the automated task sequence, route the claim to a manual task completion module and update the claim data to indicate that the particular task cannot be completed within the automated task sequence;
receive the claim from the manual task completion module;
analyze the claim data to identify a code, the code identifying a task within the automated task sequence that is next to be completed for the claim; and route the claim to the identified task within the automated task sequence that is next to be completed for the claim.
